(19) United States
(12) Patent Application Publication
(10) Pub. No.: US 2017/0094490 A1
(43) Pub. Date: Mar. 30, 2017

(54) METHOD AND SYSTEM FOR WIRELESS COMMUNICATION IN EMERGENCY SITUATION

(71) Applicant: GeoVisible, Inc., Seattle, WA (US)

(72) Inventors: Dave RYAN, Seattle, WA (US); Charles IMMENDORF, Seattle, WA (US)

(21) Appl. No.: 15/371,998

(22) Filed: Dec. 7, 2016

Related U.S. Application Data
(63) Continuation-in-part of application No. 15/201,168, filed on Jul. 1, 2016.
(60) Provisional application No. 62/276,177, filed on Jan. 7, 2016.
(60) Provisional application No. 62/276,181, filed on Jan. 7, 2016.
(60) Provisional application No. 62/190,450, filed on Jul. 9, 2015.
(60) Provisional application No. 62/190,445, filed on Jul. 9, 2015.

(51) Int. Cl. H04W 4/22; H04M 1/725; H04W 4/02

(52) U.S. Cl. CPC H04W 4/22; H04W 4/021; H04M 1/72536

(57) ABSTRACT

A method for communicating in a cellular network includes receiving location and time data for a plurality of user equipment (UEs) in a cellular communications network at an emergency server that provides emergency services to the plurality of UEs, storing the location and time data in a secure memory of the emergency server, receiving an emergency notification associated with a missing person at the emergency server, correlating, by the emergency server, the stored location and time data with data of the emergency notification to determine a set of volunteer witness UEs, and transmitting volunteer witness request messages to the set of volunteer witness UEs.

### CROSS-REFERENCES TO RELATED APPLICATIONS

The present disclosure claims priority to U.S. Provisional Application No. 62/276,177, filed on Jan. 7, 2016, to U.S. Provisional Application No. 62/276,181, filed on Jan. 7, 2016, and is a continuation-in-part of and claims priority to U.S. application Ser. No. 15/201,168, filed Jul. 1, 2016, which in turn claims priority to U.S. Provisional Application No. 62/190,450, filed Jul. 9, 2015 and to U.S. Provisional Application No. 62/190,445, filed Jul. 9, 2015, each of which are incorporated by reference herein for all purposes.

### BACKGROUND

Technologies used in modern wireless communications devices such as smartphones, tablets and other personal communications devices are advancing at a rapid rate. However, many systems that could take advantage of these capabilities have not evolved at the same rate. In particular, current emergency service providers are typically only capable of communicating with modern wireless communication devices through a voice channel.

Modern wireless communication devices have the capability to collect and provide information that is helpful to many emergency services, including a missing persons search. Emergency services, including missing persons and event security, would benefit from a system that utilizes technologies available to modern devices.

### BRIEF SUMMARY

Embodiments of this disclosure provide a method and system for locating missing persons using cellular communications technologies. The systems and methods described in this disclosure collect and securely store user location information. The information may be used to assist law enforcement personnel during missing persons work including search and rescue. Embodiments of this disclosure include data privacy and record keeping of access to private user data to ensure security of stored user data and to prevent misuse of collected user data.

A method according to an embodiment of the present disclosure includes receiving location and time data for a plurality of user equipment (UEs) in a cellular communications network at an emergency server that provides emergency services to the plurality of UEs, storing the location and time data in a secure memory of the emergency server, receiving an emergency notification associated with a missing person at the emergency server, correlating, by the emergency server, the stored location and time data with data of the emergency notification to determine a set of volunteer witness UEs, and transmitting volunteer witness request messages to the set of volunteer witness UEs.

The method may include deleting the location and time data from the secure memory after a predetermined time interval. In an embodiment, the emergency server receives the location and time data from at least one of an enhanced Serving Mobile Location Server (eSMLC) and a Serving Mobile Location Server (SMLC). The emergency notification may be received from a law enforcement agency, and may include location and time data of an event associated with disappearance of the missing person.

In an embodiment, correlating includes establishing a first geofence around a location associated with the missing person and determining a first portion UEs of the plurality of UEs that are within an area bounded by the geofence within a time associated with the missing person, wherein the first portion of UEs is the set of volunteer witness UEs.

The emergency server may store authorizations to contact the plurality of UEs regarding volunteer witness services. In addition, the method may further include receiving at least one response to the volunteer witness request messages, and transmitting the received response to a law enforcement agency.

### BRIEF DESCRIPTION OF THE DRAWINGS

FIG. 1 illustrates a wireless communications system according to an embodiment.

FIG. 2 illustrates a network device according to an embodiment.

FIG. 3 illustrates an embodiment of an emergency management system.

FIG. 4 illustrates an embodiment of a process for locating missing persons.

FIG. 5 illustrates an embodiment of collecting location data.

FIG. 6 illustrates an embodiment of a process for volunteer witness messaging.

FIG. 7 illustrates an embodiment of a system that performs volunteer witness messaging.

FIG. 8 illustrates an embodiment of a process for providing access to venue emergency services through user equipment.

FIG. 9 illustrates an embodiment of an emergency management system providing access to venue emergency services.

### DETAILED DESCRIPTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

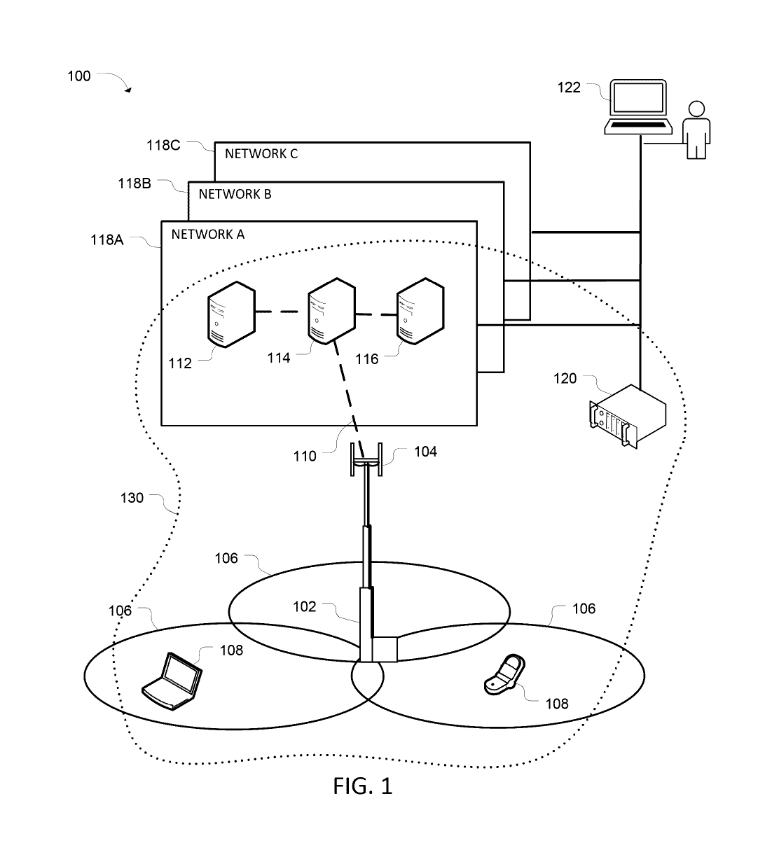

FIG. 1 illustrates a networked wireless communications system 100 according to an embodiment. System 100 may include one or more base stations 102, each of which are equipped with one or more antennas 104. Each of the antennas 104 may provide wireless communication for user equipment 108 in one or more cells 106. As used herein, the term “base station” refers to a wireless communications station that serves as a hub of a wireless network. For example, in a Long Term Evolution (LTE) cellular network, a base station may be an eNodeB.

The base stations 102 may provide service for macrocells, microcells, picocells, or femtocells 106. FIG. 1 shows an embodiment in which base station 102 provides wireless communication services to three cells 106. The cells may be specific to a particular Radio Access Technology (RAT) such as GSM, UMTS, LTE, etc.

Due to the directionality of some RF antennas 104, each base station 102 may serve a plurality of cells arrayed about the base station site. In a typical deployment, a base station 102 provides functionality of three to six cells 106, which are deployed in a sectorized fashion at a site. In other embodiments, one or more base station 102 may be outfitted with an omnidirectional antenna that provides service to a single cell for a given RAT. Multiple base stations 102 may be present at a site and each base station may support one or more cellular communications technologies (e.g., a base station may support UMTS and LTE cells). The one or more UE 108 may include cell phone devices, laptop computers, handheld gaming units, electronic book devices and tablet PCs, and any other type of common portable wireless computing device that may be provided with wireless communications service by a base station 102.

The system 100 may include a backhaul portion 110 that can facilitate distributed network communications between backhaul equipment 112, 114 and 116 and one or more base station 102 within a first operator network 118A. In an embodiment, the backhaul portion of the network includes intermediate links between a backbone of the network which is generally wire line, and sub networks or base stations 102 located at the periphery of the network. The network connection between any of the base stations 102 and the rest of the world may initiate with a link to the backhaul portion of a provider's communications network. The backhaul 110 may include an X2 connection through which base stations 102 communicate with one another directly.

The devices 112, 114 and 116 may be any of a plurality of network equipment such as a Radio Resource Manager (RRM), a Mobility Management Entity (MME), a serving gateway (S-GW), a Radio Network Controller (RNC), a base station controller (BSC), a mobile switching center (MSC), a Self-Organizing Network (SON) server, an Evolved Serving Mobile Location Server (eSMLC), a Home Subscriber Server (HSS) etc. Persons of skill in the art will recognize that network devices 112, 114 and 116 are different depending on the particular RAT or set of RATs that are provided in first operator network 118A.

FIG. 1 shows three different networks 118A, 118B and 118C that are controlled by different operators. In an embodiment, the different operators are independent licensors of RF spectrum, where the different operators control different portions of spectrum. For example, RF spectrum in the U.S.A. is auctioned by the FCC to various cellular providers, which operate separate and independent networks 118A, 118B and 118C. In other embodiments, a network may be controlled by some other entity such as a business or government agency.

In the embodiment of FIG. 1, the three independent networks 118A, 118B and 118C are coupled to an emergency mediation server 120. An emergency mediation server 120 may include one or more computer devices that provide services to a plurality of UEs 108. In an embodiment, UEs 108 may have program instructions stored thereon which, when executed by a processor, communicate with a remote computing device to provide emergency services to a user. The emergency mediation server 120 may include a database that stores preferences and settings for a plurality of users, including emergency contact groups, current locations of users, protocols for handling particular emergency situations, etc.

In an embodiment, the emergency mediation server 120 communicates directly with the Operations Support System (OSS) of one or more operator. Each operator may control and facilitate one or more respective emergency mediation server 120. In another embodiment, one or more independently controlled emergency mediation server 120 interfaces directly with backhaul server components of one or more operator network.

An emergency mediation server 120 that interfaces directly with one or more OSS provides a number of advantages over conventional UE-based emergency solutions, including the amount, type, timeliness and accuracy of data that is available to the emergency mediation server 120. At the same time, the level of complexity to establish such an interface greatly exceeds the complexity of a system which simply polls information from UEs and stores that information on a central server.

In addition, the networks 118 are coupled to an emergency dispatch center 122. An emergency dispatch center may include computer devices and personnel that receive and process requests for emergency services from users. For example, in the U.S.A., dispatch center 122 may be a 911 call center. The dispatch center 122 may receive voice and data from UE 108 directly from the networks 118. In addition, the dispatch center 122 may receive information from the emergency mediation server 120.

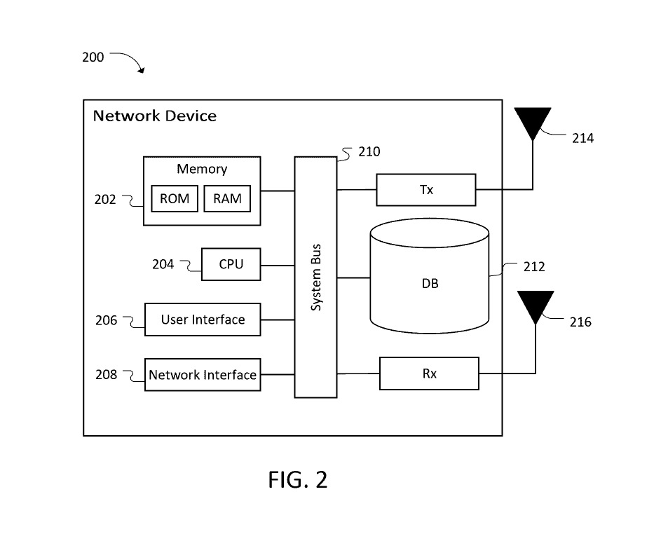

FIG. 2 illustrates a block diagram of a network device 200 that may be represent UE 108, network controller devices 110, 112 and 114, an emergency mediation server 120, etc. The network device 200 has one or more processor devices including a CPU 204. The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. The storage device 212 and ROM of memory 202 are non-volatile computer readable media that may have computer executable instructions stored thereon which, when executed by the CPU 204, cause the network device to perform one or more operations according to embodiments of the present disclosure.

The network device 200 may also include a user interface 206 that allows a user to interact with the network device's software and hardware resources and to display the performance and operation of the system 100. In addition, the network device 200 may include a network interface 206 for communicating with external devices, and a system bus 210 that facilitates data communications between the hardware resources of the network device. If the Network device has wireless connectivity, it may have a transmitter 214 and a receiver 216, each of which may include one or more antennas that operate on one or more frequencies.

Embodiments of the present disclosure may be performed by an emergency system 130 that performs a plurality of emergency-related processes. An emergency system 130 may include one or more of the network components shown in FIG. 1, such as the emergency mediation server 120, network devices 112, 114 and 116, user equipment 108, and base station 102. In some embodiments, an emergency system 130 is based on an emergency mediation server 120 with computer-readable instructions stored thereon which, when executed by one or more processor of the mediation server, provide emergency services.

An emergency system may receive, process and route emergency requests between subscribers and the emergency dispatch center 122. In an embodiment, the emergency system 130 may transmit a request for an accurate location (e.g. latitude, longitude) to a geo-location system when not provided as part of the normal emergency call procedure (e.g. for emergency requests initiated through a mechanism other than a 911 call). The geo-location processes may be implemented by the emergency mediation server 120 or may be provided as a service through interfaces to a geolocation system of an operator's OSS, such as an eSMLC.

The emergency system 130 may maintain a subscriber register which includes subscriber profiles and details on subscribers' authorized emergency proxy groups and emergency notification groups with various levels of security. The subscriber register may be implemented as a database of emergency mediation server 120. The subscribers may be users that are subscribed to emergency services provided by the emergency system 130.

An emergency system may be implemented within existing switching systems in the cellular network, and/or as a separate hardware entity with interfaces to a cellular network. A single emergency system may interface to a single cellular network 118 or to multiple cellular networks such as networks 118A, 118B and 118C maintained by different operators.

The emergency system 130 is also capable of storing emergency requests which originate from the emergency dispatch center 122 and performing automated monitoring of the targeted subscriber to enable onward transmission of the requests immediately as conditions allow, for example when a location area update is seen for the subscriber.

The emergency system 130 may also interact with subscriber devices, e.g. UE 108, to ensure that information is only provided to the emergency dispatch center 122 if the subscriber permits this information to be shared. For example, in an embodiment, a subscriber's information is only forwarded to the emergency dispatch center 122 if the subscriber actually places a call to the emergency dispatch center 122. The subscriber's UE 108 may provide confirmation of such a call being placed in a cryptographically secure fashion. This can help prevent malicious or unauthorized retrieval of subscriber information by the emergency dispatch center 122.

In addition, the emergency system 130 may determine a set of cells that define a specific geographic (geo-fenced) area for one or more operational cellular networks 118 in the vicinity of an emergency event. The emergency system 130 may identify, track, and/or confirm the presence of all subscribers within the geo-fenced area and coordinate messaging, status updates and other activities for those subscribers.

In an embodiment, the emergency dispatch center 122 receives incoming emergency requests from subscribers as well as incoming emergency requests in the form of phone calls from family or other members of an emergency proxy group who may be concerned about a subscriber. Elements of the emergency system 130 may be located at an emergency dispatch center 122, such as a hardware device that performs one or more processes in conjunction with other elements of the emergency system to provide subscribers with emergency services.

When an emergency request is received at an emergency dispatch center 122, a determination may be made on the optimal course of action. The emergency dispatch center 122 may then request the emergency system 130 to perform the action. For example, the emergency dispatch center 122 can request the emergency system 130 to transmit communications to all members of an emergency notification group, or to user equipment within a geo-fenced area.

In an embodiment, UEs in a network have a set of program instructions stored thereon that extend functionality of the UE and interface with one or more external hardware devices to provide emergency services to the user. The emergency services may include, for example, the ability for the user to configure one or more emergency notification groups, configure one or more emergency proxy groups, and accept or reject invitations to join other users' emergency notification groups or emergency proxy groups. For example, a subscriber may have one emergency notification group for medical emergencies, one for emergencies related to a car breaking down, etc.

Subscribers may be members of multiple emergency notification groups or emergency proxy groups created by other subscribers. When a subscriber adds a member to a group, an emergency application sends a message to the member, inviting him/her to join the group. The member may accept or reject the invitation. Group information may be stored in a database of an emergency mediation server 120.

In an embodiment, the UE 108 may be in communication with the emergency mediation server 120, and the emergency mediation server may communicate with the UE as well as an emergency dispatch center 122. Accordingly, the emergency mediation server 120 may facilitate communication between the UE 108 and the emergency dispatch center 122, instead of or in addition to communications directly from the UE 108 to the emergency dispatch center 122.

In an embodiment, when a subscriber makes a call to an emergency number such as 911, an emergency request may be automatically transmitted to the emergency mediation server 120, or a request may be transmitted directly to the emergency mediation server 120 from UE 108. On submission of a subscriber initiated emergency request or on reception of dispatch initiated emergency request, UE 108 may perform several processes, including silent initiation of a call in which a data connection is setup through the cellular network, and silent initiation of audio and/or video recording and retrieval of location data, e.g. GPS and Wi-Fi data from the UE.

The data connection between the UE and the emergency mediation server 120 may be used to transfer information about the subscriber including their location data, UE status (e.g. battery level), emergency request type and video/audio data stream to/from the emergency dispatch center 122. In addition, the emergency system 130 may be capable of storing a subscriber initiated emergency request when the UE is out of cellular coverage range and, and performing automated monitoring of the cellular network conditions for onward transmission of the emergency request immediately as conditions allow. In addition, the emergency system 130 may enable forced continuation of the data connection even if the normal emergency call has been terminated and the UE 108 is turned “off.”

In an embodiment, a data connection is established between the emergency dispatch center 122 and the emergency mediation server 120 that provides UE data to the emergency dispatch center. For example, the UE 108 may provide one or more of location data, cell phone status data (e.g. battery level), emergency request data related to a category of emergency request, audio data and video data to the emergency mediation server 120. Such data may be processed by the emergency mediation server 120, and selectively transmitted to the emergency dispatch center 122.

Communications between the UE 108, the emergency mediation server 120 and the emergency mediation server 120 may be protected by one or more security mechanism. For example, elements of the UE that relate to emergency services may be protected by a password, in addition to or instead of biometric protection. Data related to the emergency services that is stored on the UE may be encrypted, and all emergency communications between the UE 108 and the emergency mediation server 120 and between the emergency mediation server and the emergency dispatch center 122 may be encrypted as well.

In some embodiments, the UE 108 is authenticated to the emergency mediation server 120, so that the emergency mediation server only accepts communications from authenticated hardware, thereby prohibiting unauthorized devices from communicating on behalf of a particular subscriber. The emergency mediation server 120 may authenticate all communications to and from the emergency dispatch center 122. In addition, membership in various emergency notification groups and emergency proxy groups may require verification from members before they are added to the groups.

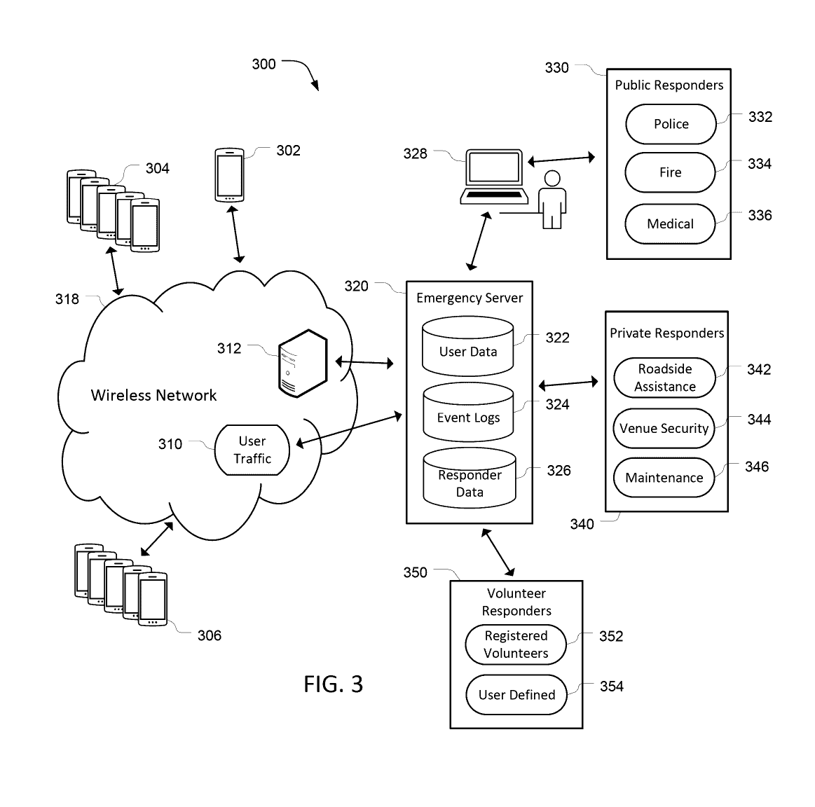

FIG. 3 shows an embodiment of a system 300 for geolocation and communication with emergency responders. In system 300, an emergency caller has a UE 302 that is in communication with wireless network 318. The emergency caller's UE may implement software that is specific to one or more of the emergency management processes described by this disclosure. The software may be implemented in the form of a dedicated application (EEMS_APP), and/or software that is provided by an operator or telephone manufacturer.

Emergency caller UE 302 may initiate an emergency response process in response to an emergency situation. Alternatively, a process may be initiated in other ways such as a missing persons search initiated by traditional emergency services personnel or by concerned third parties. For example, an emergency response process could be initiated by a municipal entity in response to a natural disaster, or a private business in response to a hazardous situation that occurs on the business premises such as a chemical leak or explosion.

System 300 supports users with wireless devices that are not equipped with, or not currently running, the EEMS_App software. In these cases, the emergency caller UE 302 may be treated as a target UE identified by a device phone number, IP address, Electronic Serial Number (ESN), etc. Accordingly, a user that is the subject of an emergency situation may be referred to generally as a victim or subject of an emergency response.

Wireless network 318 may be a wireless cellular communication network that is maintained by a single telecommunications operator. In some embodiments, the wireless network may 318 include local wireless elements such as Wi-Fi links that couple UE to the Internet through local area networks.

The wireless network 318 includes a location server 312, which may be an eSMLC or SMLC. Location server 312 employs existing and/or enhanced UE location technologies embedded within the wireless network 318. Location server 312 may utilize a variety of processes to estimate the current location of individual system users when requested to do so via external data interfaces. Traditional location servers utilize GPS positioning capabilities of individual UE, and/or position estimates based on cell connectivity and/or measurements made at individual serving and nearby neighbor cells. The performance of embodiments may be improved by enhancing the capabilities of traditional location servers to support geofencing and other features.

The wireless network 318 includes a user traffic subsystem 310, which comprises the content of communications of individuals or groups of system users. Types of user traffic handled by the user traffic subsystem 310 include voice calls, SMS and MMS text messaging, video traffic, and other data transferred to and from system users.

The system 300 includes an emergency coordination server 320, which may be the same physical entity as the emergency mediation server 120 discussed above. The emergency coordination server 320 includes subsystems and performs processes that coordinate and support emergency services for users, victims and responders. An emergency coordination server 320 may be integrated into the network of one or more operator, or a system may include a single server that is coupled to multiple operator networks. Elements of emergency server 320 may be distributed across multiple physical locations.

Information retained by emergency server 320 includes user data 322. System users utilizing the EEMS_App may optionally store personal information into this secure data archive for use during an emergency. User data 322 may include, for example, medical history, drug allergies, primary care physician, family contacts, insurance information, etc. Information stored in this subsystem, especially sensitive personal information, is protected via security mechanisms such as passwords and data encryption and access may be limited during emergencies according to user defined rules. All attempts to access user stored data may be recorded and available for review by users to ensure privacy and data access accountability.

System activities are logged for later review and event auditing in event logs 324 stored by the emergency server 320. The system activities stored by the event logs 324 may include individual and group messaging generated or received by the EEMS_App and the emergency server 320, data shared between responders, location data, etc.

The emergency server 320 may coordinate groups of responders for emergency situations through wireless network 318. FIG. 3 shows two such groups, which are a caller defined group 304 and a dynamically defined group 306. One or more caller defined group 304 may be defined by a given subject 302 to respond to emergencies depending on the nature of the emergency situation. For example, a subject 302 may define a first emergency group 304 for emergency situations in a first geographic region, and a second group for situations in a second geographic region.

In addition, emergency server 320 may coordinate a dynamically defined emergency responder group 306, which may include public responders 330, private responders 340, and volunteer responders 350. Public responders 330 are publically funded or available emergency responders such as police 332, fire personnel 334, and medical personnel 336. Private responders 340 may include a variety of emergency responders that are privately employed, typically for the purpose of providing emergency response services, such as roadside assistance 342, venue security 344, and maintenance personnel 346.

Volunteer responders 350 may include any responders that respond on a voluntary basis, and may include a variety of sources. Volunteer responders may be registered volunteers 352 which are registered directly with the system or an independent agency. An architectural subsystem of system 300 may support the creation of and access to data records of these pre-screened and authorized non-traditional emergency services personnel such that they can be called into service when needed.

Registered volunteers 352 could be volunteer firemen for a geographic region, persons with first aid or similar skill sets that are pre-screened and registered to the emergency server 320, search and rescue volunteers, etc. Other examples of volunteer responders 350 are off-duty emergency responders or medical personnel, volunteer search and rescue personnel, registered roadside assistance personnel, non-professional emergency first responders to assist in large scale emergencies, neighborhood/campus watch volunteers, etc. In addition, a user defined set of volunteers 354 may include responders from the caller defined response group 304.

The system 300 may create and maintain a dynamic list of members of the dynamic responder group 306 along with messaging and tracking guidelines based on group roles and responsibilities. For instance, on-site personnel engaged in hazardous situations (e.g. on-site fire fighters, technical terrain search and rescue teams, etc.) may optionally be position tracked and may have more stringent communication rules than assisting off-site personnel (e.g. hospital admitting staff).

The emergency server 320 is in communication with an emergency dispatch center 328, e.g. a 911 call center. The connection to the emergency dispatch center 328 facilitates access to a variety of public responders 330 for the emergency server 320. While specific emergency dispatch service implementations vary by locale and region, these services are typically provided by emergency dispatch centers 328 with one or more call center operators that call upon public emergency response teams in the event of an emergency.

In some cases, depending on the circumstances of an emergency, system 300 may simply pass incoming user generated emergency calls directly to the appropriate local 911 dispatch center 328. However, in other circumstances, emergency server 320 may manage, organize and facilitate communications for public responders 330. For example, an initial set of public responders may be identified at the call center 328 at the onset of an emergency, and transmit public responder data 326 to emergency server 320 to use to coordinate a response to the emergency. Responder data 326 may include data related to any responder, including public, private and volunteer responders.

### Missing Persons

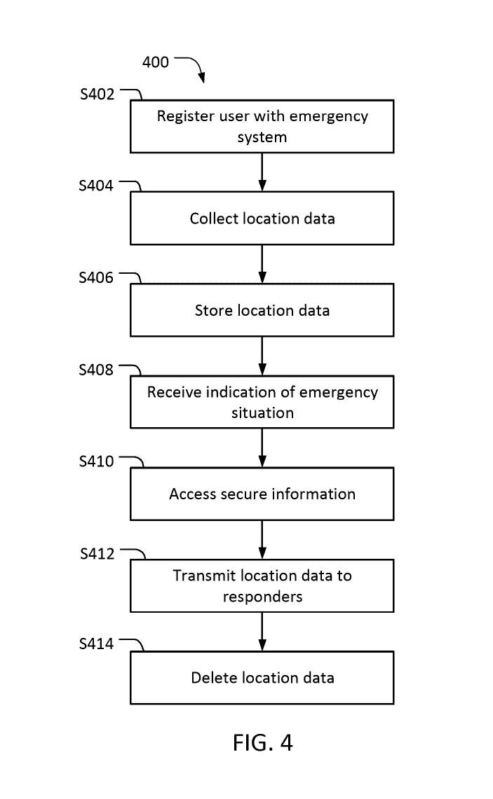

FIG. 4 shows a process 400 for locating missing persons according to an embodiment. A user is registered with an emergency system at S402. Registering with the emergency system may include providing personal details of a user, including name, birth date, a picture, identifying features, and other information that could be used to identify the user. In addition, user registration S402 may include providing medical information that could be useful to emergency responders, such as drug allergies and medical conditions.

When a user registers with the emergency system, the user may be prompted to decide whether to opt into specific services. A user may be prompted to assent to having location data tracked and recorded, for at least a limited time, for use by the emergency system. The user may be prompted at S402 to provide location data to responders, including law enforcement personnel, for purposes of identifying witnesses and finding missing persons.

When a user registers with the emergency system at S402, the registration process may solicit parameters for data retention. For example, a user may be able to designate an amount of time for which location data is stored, specific parties that location information is provided to, access permissions including the identities of third parties that can be granted access to the location data, as well as the circumstances under which such access is to be granted. It may be possible for a user to provide and change this and other information at any point through an emergency application.

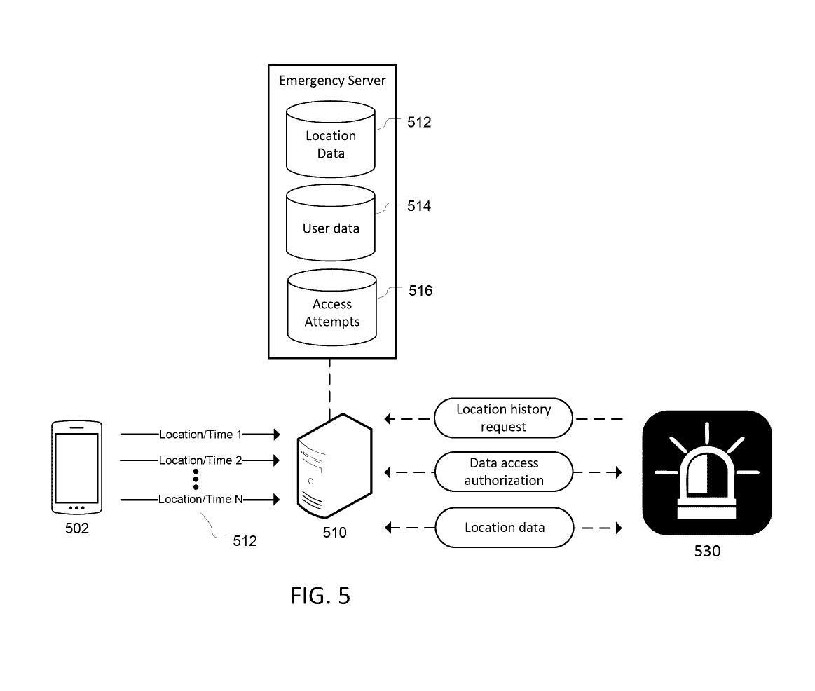

Location data is collected from a user's mobile device at S404. Collecting location data is illustrated by FIG. 5, which shows timestamped location data 512 being transmitted from UE 502 to an emergency server 510. Location data 512 may be transmitted on a periodic basis, such as every second, every several seconds, every minute, every half hour, etc. The location element of the location data may be GPS data collected from a GPS receiver built into UE 502.

In another embodiment, location data 512 may be collected at S404 by the emergency server 510 from a cellular network provider. For example, a cellular network may track the location of a UE 502 using, for example, time of flight data collected by cellular base stations. In particular, location data 512 may be collected from a location server 310, e.g. an SMLC or eSMLC, coupled to a backhaul of a wireless network 318.

Emergency server 510 may communicate with a cellular network using an equipment identifier such as an International Mobile Subscriber Identity (IMSI) collected at S402.

Location data 512 is stored by the emergency server 510 at S406. The location data 512 stored by the emergency server 510 may be stored in a secure, encrypted format. To enhance security, all attempts to access data 512 and 514 may be stored by the emergency server 510 as access attempts 516 as well.

Additional measures of security may be used to protect location data 512 stored by the emergency server 510. For example, the location data 512 can be stored in a storage location that is independent from personally identifying user data 514 of a user of UE 502. Instead, the location data may be identified based on an arbitrary identifier that is linked to the remotely stored personal data 514. In such an embodiment, different security keys may be required to decrypt the location data 512 from the secure user data 514.

An indication of an emergency situation is received by emergency server 510 at S408. The emergency situation may be a missing persons situation, or some other situation, such as a natural disaster, in which the locations of persons affected by the emergency are not known. In embodiments, the emergency situation is the failure of a UE 502 to transmit location data 512 within certain geographic and/or time boundaries. In another embodiment, the emergency situation may be input into UE 502 by a user and transmitted to emergency server 510. In still another embodiment, the indication is received from emergency service providers such as emergency call center 530.

When the emergency server 510 receives an indication of an emergency situation at S408, a series of processes related to providing user location information to one or more contact or emergency responder personnel may be initiated to access secure information at S410. The location data 512 and user data 514 may be locked against unauthorized access and only be accessible via a request and authorization process, such as a process initiated by law enforcement agents.

The indication of the emergency situation may be received as an electronic signal through a communications network. In one embodiment, the indication is initiated by a UE through the EEMS_APP, where the UE transmits data indicating a missing person. The data indication may be transmitted through a cellular network, packetized, and transmitted through the Internet to emergency server 510.

One example of an indication of an emergency situation is a parent whose child did not arrive at home at an expected time. In this example, the parent, who is authorized to have access to the child's location data, transmits an indication that the child is missing to the emergency server 510, and receives a response including location data collected from UE belonging to the child.

In an embodiment, when an official law enforcement investigation is initiated a request is made to access stored location data 512 and user data 514, the request must be validated by the system to allow access to secure data. All successful or unsuccessful attempts to access secure user data 516 may be logged by emergency server 510, which may be viewed by the user.

Data access security may be further enhanced by requiring multiple correct keys to successfully access stored user data 514 and location data 512. For example, access to user data records may require one or more of an authorized law enforcement request, an approval by system administrators, and an additional security key stored elsewhere such as with a trusted family member. Various levels of data security are possible, such that valuable safety data may be collected but not easily abused.

On successful authentication and access, the location data 524 is transmitted to one or more responder at 5412. The responder may be various emergency response personnel including law enforcement agencies, search and rescue services, a central emergency call center 530, one or more member of an emergency contact list, etc. In another embodiment, a responder is an authorized representative of the missing person, such as a parent, spouse, or person that the user has designated with the authority to receive location information of the missing person.

Archived location data 512 is deleted at S414. Archived location data 512 may be deleted at a periodic interval, so that data is never retained for longer than a predetermined time. For example, in one embodiment, location data 512 for the previous day is deleted at the end of the current week, so that no less than one day and no greater than two weeks of location data 512 are stored at emergency server 510.

The amount of location data 512 and the time it is retained may be configurable by a user. In addition, all stored location data 512 may be purged at any point by a user. The user may have to provide a form of identification and/or authentication for clearing the location data 512, for example via the entry of a private secure data deletion password. The user may set a trigger condition for deleting location data 512, such as indicating safe arrival at a destination, so that location data is only deleted at S414 when the trigger condition is met.

In addition to data collected and stored pertaining to a missing person, embodiments of this disclosure may correlate information of other system users, such that other users may volunteer additional information regarding a last known position of a missing person or circumstances surrounding the disappearance of the missing person or an emergency situation that may be associated with the missing person. Such an embodiment may employ strong data security measures to protect individual user data, and use and processes designed to provide privacy for potential volunteer witnesses as well as the missing person.

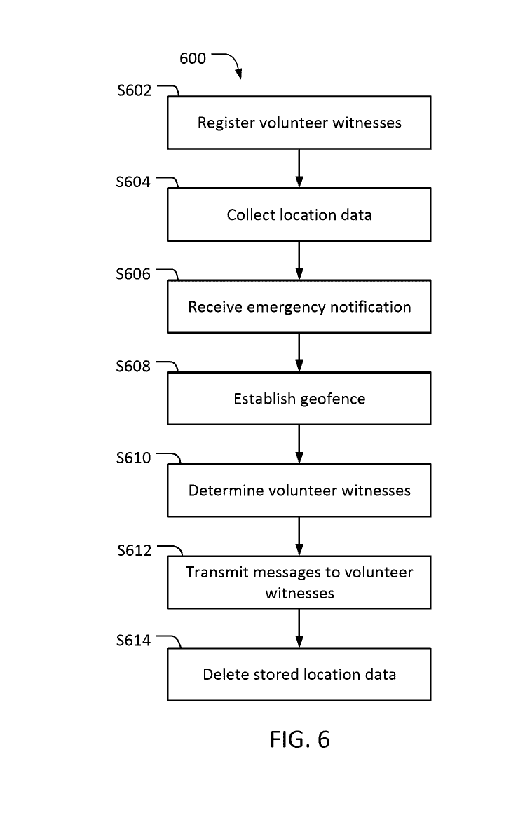

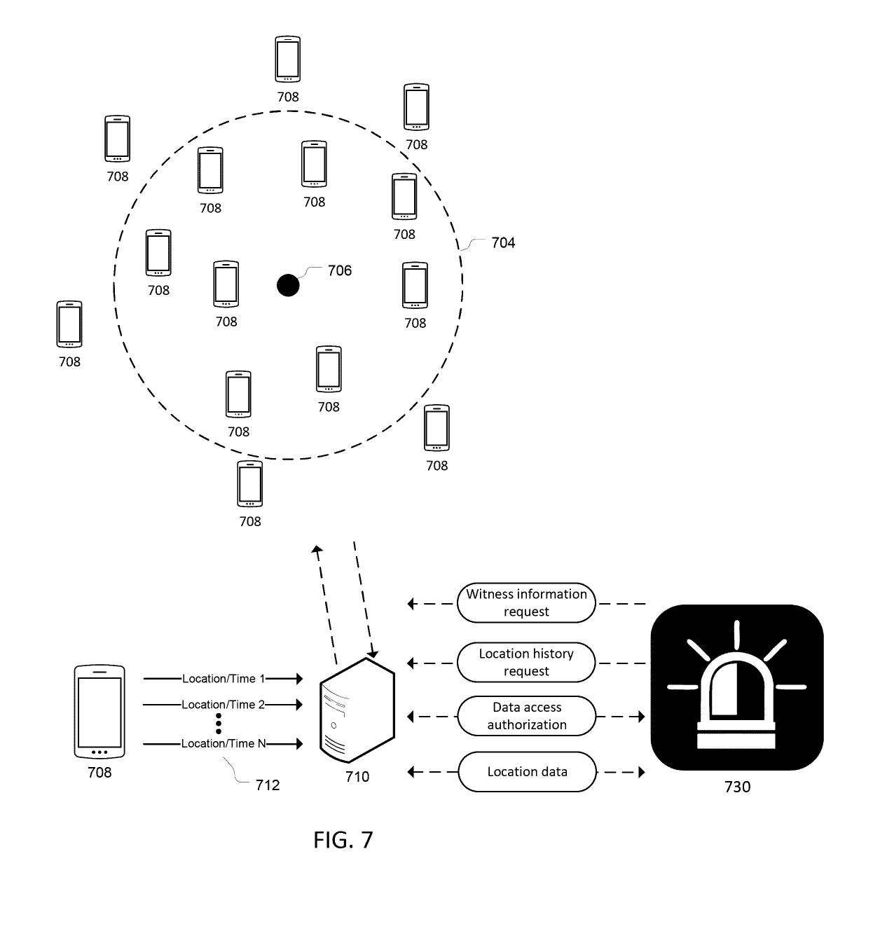

FIG. 6 shows an embodiment of a process 600 for volunteer witness messaging, and FIG. 7 illustrates a system that performs volunteer witness messaging. Volunteer witnesses register with emergency server 710 at S602. The registration process may be performed at the same time that users register with the emergency system at S402. Users may be prompted to indicate whether they are willing to provide location data that could be used in the event of a missing person. In addition, the volunteer witnesses may indicate whether they are willing to provide location data and be contacted in the case of other emergency situations.

Location data 712 is collected at S604 from UEs 708 of users that registered as volunteer witnesses. The UEs 708 may provide periodic location data reports 712 to the emergency server 710. In an embodiment, UEs 708 have periodic position tracking enabled and may independently store their own tracking information in one or more secure archival database. In an embodiment, limited location data 712 is transmitted to emergency server 710, while more detailed location data is stored by the UE 708. Such limited location data 712 may be used, for example, to determine that one or more UE 708 is a candidate witness within the vicinity of an emergency situation, and UE 708 may provide more detailed location data to emergency server 710 to refine the set of potential witnesses.

An indication of an emergency situation is received by emergency server 710 at S606. The emergency situation may be a missing persons situation, or some other situation, such as a natural disaster, in which the locations of persons affected by the emergency are not known. In an embodiment, the emergency situation is the failure of a victim's UE to transmit location data 704 within certain geographic and/or time boundaries. In another embodiment, the emergency situation may be input into UE by a user and transmitted to emergency server 710. In still another embodiment, the indication is received from emergency service providers such as emergency call center 730.

A geofence 704 in which to identify UEs 708 of volunteer witnesses is established at 5608 based on the emergency situation. The geofence 704 is centered around a point 706, which may be the last known location of a missing person. When the missing person is using an EEMS_APP with location information enabled, the point 706 may be determined from location data 712 of the victim's UE.

The extent of an area enclosed by geofence 704 may depend on a number of factors. One factor is the nature of the nature of the emergency situation. Some emergencies have a larger affected area than others, and some areas, such as low density open areas, have longer sightlines than areas such as high-density metropolitan downtown corridors, so the size of a geofence 704 may be scaled to the affected area.

In an embodiment, the geofence 704 is determined by an external agency such as an emergency dispatcher 730 or law enforcement agent that has situational awareness, and provides the geofenced area to emergency server 710. In another embodiment, an emergency management system may determine a geofence 704 using information received from an emergency call center 730 or other external agency. For example, an emergency call center 730 may indicate a last known location, e.g. point 706, of a missing person. In other embodiments, the emergency server 710 determines a geofence 704 without input from the external agency.

Volunteer witnesses for the emergency situation identified at S606 are determined at S610. Volunteer witnesses may be determined by correlating location data 712 received from volunteer witness UEs 708 with time and location information associated with the missing person, or location data of some other emergency situation. Such correlation may include determining which volunteer witness UEs 708 were within geofence 704 at a time or set of times associated with the disappearance of the missing person, or the occurrence of the emergency situation.

Correlating the stored location data 712 with time and location data of a missing person may include several elements. For example, the emergency server 710 may receive an emergency notification from a law enforcement agency that indicates one specific time and location, such as a time and location that a kidnapping event was reported. In such an embodiment, the emergency server 710 may establish a time window and geofence based on the time and location points in the emergency notification. In embodiments, the time and location in the notification may be a window of time and an area.

In an embodiment, correlating the stored location and time data 712 with the emergency notification includes determining which volunteer witness UEs 708 transmitted location and time data that is within the geofence and within the window of time. Accordingly, volunteer witnesses are identified at S610 by determining a set of UEs that are most likely to have relevant information related to the disappearance of a missing person, or other emergency situation.

In an embodiment, only those witnesses that choose to contact law enforcement may be identified at S610. Identifying volunteers may be supported by time and position information such that potential witness correlation may occur without exposing the actual identity of the potential witnesses to system operators. Participation is voluntary, and embodiments of this disclosure may provide time and location information to law enforcement without providing any personally identifying information of associated users to law enforcement. In such an embodiment, the emergency server 710 may mediate communications between UEs 708 and law enforcement to protect the privacy of volunteer witnesses.

In an embodiment, stored user data is tagged with an alias such that system operators cannot determine the identity of users who have stored location information, yet the emergency server 710 can determine which UE 708 were in the geofenced area 704 at a time of interest and transmit system messages to those users at S612. As a result, privacy is maintained for system users even when UEs 708 of those users are contacted in process 600.

The messages transmitted to UEs 708 of volunteer witnesses include information related to the location and time of the emergency situation in question, and may include a description or photo of a missing person. The messages may also include a request to contact authorities if the volunteer witness has information useful to resolving the emergency situation.

Location data for volunteer witnesses is deleted from the emergency server 710 at S614. In an embodiment, the location information may be automatically deleted at a periodic interval, such as one day or one week.

Embodiments of the present disclosure may include enhanced security features to protect the identities of users. Embodiments may provide the ability to encrypt and/or key stored user location data to enhance privacy, for instance to require multiple unique keys before accessing or decrypting stored data. In one embodiment law enforcement officials control one key common to all stored user accounts, and a second private user key is required to access user location data. Users would be encouraged to share their unique key or a derivative of this key only with trusted family, colleagues or friends.

In the event that a missing person's search is initiated for users, a trusted key holder would have to supply the user's key, or a publically shareable derivative, to either unlock or decrypt stored user tracking data. Embodiments of this disclosure may provide these and other multi-keyed privacy features.

Another privacy enhancement feature that may be included in embodiments is the ability for users to delete stored tracking information and/or suspend the collection of such data via a UE 708. For example, a college student returning home late at night and choosing to track the trip from their place of departure to their safe location (e.g. dorms, apartment) may wish to delete the stored location information for the trip upon arriving at a safe location by utilizing a known private key.

Embodiments may support multiple privately coded message keys. For example, a user could configure an ‘all safe’ clear key as well as an alternate ‘urgent emergency’ key. Upon accessing account configuration or other information where a user password is required, the user could choose to send a message to the emergency server 710 depending on the situation.

Embodiments may provide a process for providing secure travel for situations with heightened security concerns. For example, a user may have to walk through a suspicious area after dark on a route home from work. With a secure travel process, the user could establish time and location criteria for the walk through the suspicious area, and if the user's location deviates from location criteria within the specified time, an alert may be transmitted to one or more emergency contact of an emergency contact group 304 established by the user, and/or to other emergency responders.

In one embodiment, a user's current location information, as well as other stored user information, is transmitted to a law enforcement agency when the time and location criteria are not met. This information could be useful to law enforcement personnel to locate the user in an ensuing search.

A secure travel embodiment may use a specific limited area identified by the user for location boundaries. For example, the user may specify a location for a transaction or meeting with third party the user is not familiar with, such as a used item purchase or a blind date. Embodiments may use various criteria to trigger transmitting user safety alert messages, such as staying within or departing from a specified area within a specified time and failing to transmit an “all clear” message within a specified time.

Secure travel elements of an embodiment may provide a secure route process. In such an embodiment, a user could specify a route, such as a path between a starting location, e.g. a home, and a destination location, e.g. work. The emergency server 710 could provide a buffer to a one-dimensional path line, e.g. by adding a width to dimension to the line, to buffer the path location and reduce false positives. Buffers for pathing, location and time may be automatically applied by the emergency server 710 and/or manually configurable by a user.

### Venue Security

Embodiments of this disclosure provide a system and methods that provide rapid and direct access to private and public venue security teams via UE such as smartphones. Such embodiments create dynamic associations that provide visitors to private or public venues with increased personal security. Examples include direct access to sports stadium emergency personnel while attending a sporting event and direct access to ski patrol while resort skiing.

Embodiments of systems and methods according to this disclosure provide a visitor with rapid access to local emergency management personnel while visiting a venue supporting such services. Features include automated recognition of an emergency services equipped venue, easy opt in device configuration to access services, dynamic user interface to present location sensitive options for accessing venue security, and auto clearing of device settings after leaving the specific venue.

In an embodiment that supports venue security, users may utilize the EEMS_App to gain direct access to venue security and emergency response teams when visiting a venue supporting this technology. Examples include having access to emergency response teams while attending a sporting event at a stadium or having direct access to security teams while attending a large amusement park.

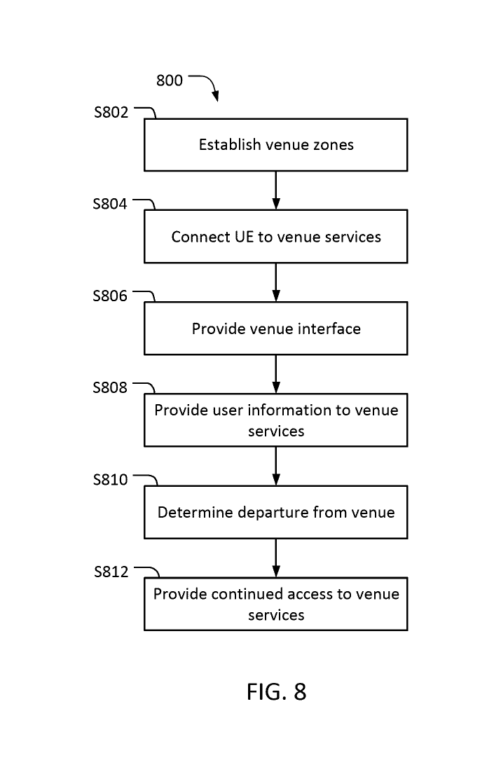

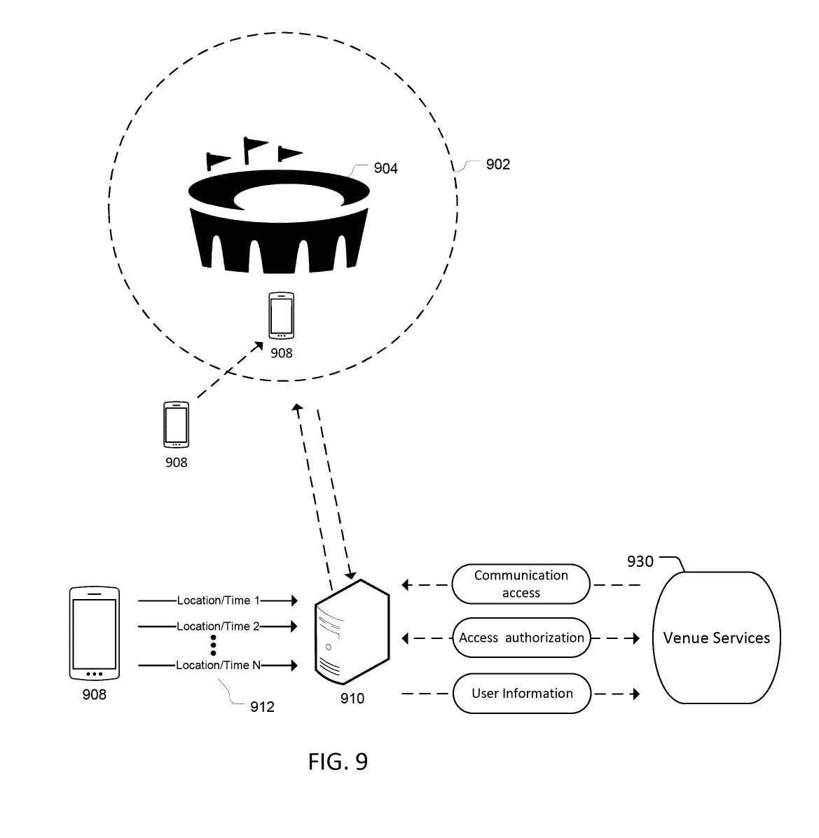

FIG. 8 shows a process 800 for providing access to venue emergency services through user equipment, while FIG. 9 shows an emergency management system providing access to venue emergency services. In order to determine whether venue services are appropriate for a user, an emergency server 910 may establish venue zones 902 at 5802.

A venue zones 902 for a venue 904 may be a predetermined geofenced area around a particular venue. Embodiments of the present disclosure are applicable to geographically constrained event venues that support emergency services. Examples of venues 904 include sporting event stadiums, theme and amusement parks, convention centers, museums, concert venues, recreational facilities such as ski resorts, mountain bike parks, water parks, and national and state parks.

An emergency system determines that UE 908 enters a venue zone 902 at S904. When it is determined that a user is within a venue zone 902 associated with technology compliant venue security, a user is prompted through UE 908 and asked whether they wish to reconfigure the UE for direct access to venue security. Users may choose not to associate with venue security, in which case no further action is taken.

In an embodiment, user device geo-location is used to detect users approaching or within a defined area near or within a given venue (e.g. sports stadium, amusement park, ski resort), in this case the E-EMS server sends a message to the user device application and the user is given the option to initiate an automatic reconfiguration of their emergency services software app. Other embodiments include pre-set user application defaults that reconfigure the user application automatically with no user intervention or manual methods whereby the user reconfigures their emergency services app without first receiving a system opt-in message.

On entering the venue zone 902, UE 908 may be manually or automatically reconfigured to provide access to stadium emergency services including medical, physical security, lost children, etc. The UE 908 may be reconfigured to include a temporary control that provides direct access to venue services 930. Direct access to venue emergency services 930 reduces an amount of calls to the conventional 911 system, and calls upon local first responders within the stadium in the event of an emergency. In an embodiment the user manually reconfigures UE 908 to support direct access to venue services 930 by, for example, hand entering a code or number into the UE or by scanning a printed electronic bar code carrying venue specific configuration parameters.

In an embodiment, UE 908 may be pre-configured to automatically accept direct connection to venue security services 930 without user intervention. For instance, user application defaults may be set to accept a generated opt-in message, and/or automatically reconfigure the user application to remove venue specific security options when the user leaves the defined venue area. When UE 908 connects to venue services 930 at 5804, venue services may be notified of the presence of a participating user. Dynamic registry of visitors to venue registry supports rapid communications to such users in the event of an emergency situation such as a lost child or medical emergency.

When a UE 908 connects to venue services 930, based on stored user preferences, venue services may be permitted access to a user's stored medical history, location, or other pertinent records in the event of an emergency. In addition, venue services 930 team may be granted access to a user's friends and family information for rapid location and communication in the event of an emergency, based on stored user preferences.

In one embodiment, emergency server 910 manages venue specific records and functions for multiple venues such as multiple sports stadiums, amusement parks, recreational centers, etc. For each of these unique venues, the specific parameters stored by server 910 may include a geographic location and venue zone 902, records of all UEs 908 currently configured for direct access to venue services 930, records of locations of registered users at each venue, and services provided by each venue and message routing parameters, e.g. phone numbers for medical, missing persons, lost and found, etc., or similar data routing parameters such as IP addresses for venue services 930.

UE 908 within venue zone 902 is provided with an interface to venue services 930 at S806. The interface may include communication channels to various specific venue services, including emergency medical services, security services, property services, and other general customer services. Providing a venue interface at S806 may add contact information such as telephone numbers or message addresses to the application configuration for the duration of the visit. This dynamic configuration may be carried out manually or via auto-detection and auto-configuration as described in a subsequent use case. Examples of S806 include dynamically reconfiguring the screen of UE 908 to include a ‘Contact Security Services’ button which appears for the duration of the venue visit.

Although FIG. 9 shows UE 908 communicating with venue services 930 through emergency server 910, in some embodiments, the UE 908 may communicate with venue services without routing information through emergency server 910.

User information 924 is provided to venue services 930 at S808. As discussed above, user information 924 may be provided to venue services 930 when UE 908 enters venue zone 902. However, in an embodiment, user information 924 may only be provided to venue services 930 when a user contacts venue services to report an emergency situation. In some embodiments, certain information such as the identity of a user is provided to venue services 930 when the user's UE 908 enters venue zone 902, but other information such as drug allergies, pertinent medical history or contact information for primary care physician, and user location data is only provided to venue services 930 in the event of an emergency.

When a user leaves venue zone 902 or otherwise indicates a desire to disconnect from venue services 930 at S810, the UE 908 may be disconnected from venue services 930. Upon leaving the venue and its GeoFenced region the user's device will be automatically reconfigured to its default settings and certain venue specific controls will be removed from the user interface.

A venue security phone number or messaging address may be optionally stored in a device log to permit quick access to venue staff via normal phone calls or messaging after app has been reconfigured to default state at S812. This feature supports post event calls for things such as lost items without having to search for the appropriate venue contact information.

Various steps of process 800, and other processes of this disclosure, may be automated. For example, with respect to venue access, user presence and opt-in may be conducted automatically. In an embodiment, the UE 908 is pre-configured to accept opt-in messages from venues 904 supporting emergency service technology, and the venue is configured to detect user devices running the security app that are within a defined support area.

Embodiments include venue proximity detection performed by the UE 908 as opposed to the emergency server 910. For example, the emergency server may be configured to transmit periodic security support multi-cast messages such that user device apps can autonomously detect the presence of a venue 904 supporting this technology and either automatically register to the service or allow user opt-in.

Several examples of an emergency system and method will now be explained. These examples are provided to illustrate how various embodiments of an emergency system can be applied in different situations. The examples are provided to enhance the understanding of the scope of this disclosure, and are not to be construed as limiting.

In a use case, a mass emergency such as an earthquake or tsunami occurs. An emergency mediation server sends an alert to all users in the vicinity of the mass emergency. In such scenarios, communications infrastructure, and in particular voice circuits to emergency call centers, are often overloaded with those trying to report their status and those checking on them. An embodiment of this disclosure may alleviate the strain on call centers by forwarding an assured delivery message to a call center even when voice circuits are not available to facilitate a voice call.

In an embodiment, users can optionally respond to an emergency alert with status (e.g. “ok” or “not ok”) and this status is automatically sent to all emergency contacts. Time stamp and any notes from the user are provided to the emergency contacts. Emergency respondents have access to the status so that can utilize this information to better mobilize their resources. In addition, the user, emergency contacts and emergency respondents can participate in a chat room.

In addition to the specific processes described above, an emergency system 130 may perform a number of processes to provide emergency-related services. Some of those processes are disclosed in the following discussion.

In some emergency situations a person in distress cannot interact directly with an emergency services operator. This could occur in scenarios such as abduction or home intrusion. An embodiment enables a covert emergency call to be automatically requested by the person in distress whenever a normal emergency call (e.g. 911 call) is initiated or through a simple sequence of actions on their cell phone. A dispatch center can then initiate services for the emergency call, including geo-location services, and instructs the UE to start video and sound recording if not already initiated. The dispatch center is then able to notify the appropriate emergency services and provide relevant details including the current location. An embodiment also enables the covert call to be continued in cases where the normal emergency call has been terminated and the phone turned “off” by the attacker or victim.

In some emergency situations, a person in distress may call or message a trusted person, such as a friend or family member, instead of an emergency dispatch center. This may occur if the person in distress is incapable of interacting directly with an emergency services operator. An embodiment enables any trusted person in a defined group (e.g., an Emergency Proxy Group) to contact the dispatch center on behalf of the person in distress and for the dispatch center to initiate a call from the cellular network to the device of the person in distress by a dispatch initiated emergency request. The trusted person determines if the call should be covert or a normal connection. Through the established data connection the dispatch center then initiates a request for geo-location and other information for the device and commences video and sound recording. The dispatch center then notifies the emergency services and provides all relevant information collected including the current location.

In some emergency situations, a person may wish to message and/or locate all members of a group such as trusted friends or familial group as configured by the user. This can be in conjunction with a missing person or an incident that affects another member of that group. An embodiment enables the dispatch center, on behalf of the person in distress, to message and/or establish contact with all Emergency Notification Group members and determine their location.

In some emergency situations, it is possible that a person in distress is outside of a cellular network coverage area. This could be in a remote location during a hiking or sailing trip or in other out of coverage areas such as an underground car park or elevator. An embodiment enables an emergency notification to be stored on the mobile phone for relay to the dispatch center as soon as network conditions allow the message to be sent.

In an embodiment, a 911 call is made by a subscriber. A 911 dispatcher sends a user emergency information request to the emergency system. When the dispatcher requests emergency information from the emergency system, the system can a user's cell phone to see if a 911 call is actually taking place. The emergency mediation server retrieves the user's information configured by the caller (e.g., name, address, medical information, photos, etc.). The emergency mediation server 120 then provides this information to the 911 Dispatcher.

In another embodiment, a 911 call is made by a subscriber. The 911 dispatcher transmits a user emergency active request to the emergency mediation server, and a message is transmitted to the 911 caller's UE. The UE is configured to perform a defined set of actions based on user settings. In an embodiment, these actions include enabling GPS in emergency e.g., if disabled otherwise for privacy; enable remote monitoring capabilities (e.g. prevent phone from turn off or entering airplane mode); and enable UE to alert user of emergency even if device is in silent mode (e.g., in silent mode for meeting when an emergency occurs with one of the user's emergency contacts or an emergency dispatcher contacting UE with an emergency condition).

In another embodiment, a 911 call is made by a subscriber. A 911 dispatcher sends a message to ab eSMLC server to locate the 911 caller. The 911 dispatcher transmits an Emergency Notification request to the emergency mediation server, which looks up the 911 caller's emergency contacts (family, friends, co-workers, doctors, etc.) as configured in a relevant Emergency Notification Group. The emergency mediation server sends a special alert to the device of each emergency contact indicating an emergency situation and location of 911 caller. The emergency mediation server sends contacts periodic messages with updates on 911 caller's location, as well as messages informing them when the 911 call ends. The 911 caller and contacts can share broadcast updates, and the 911 caller can transmit an “All Clear” message to the group.

In another embodiment, a 911 call is made by a third party regarding a subscriber, and the 3rd party is configured in the subscriber's Emergency Proxy Group. The 911 dispatcher sends message to an eSMLC server to locate a subscriber. The emergency mediation server 120 looks up the subscriber's details. The emergency mediation server determines the mobile network for the subscriber, and transmits commands to the eSMLC server to track the location of the subscriber. The server then reports back to the dispatcher the location of the subscriber, and continues to track and provide periodic updates to the dispatcher.

In another embodiment, a 911 call is made by a subscriber. The 911 dispatcher transmits a message to the eSMLC server to locate subscriber, and transmits a Multiparty Locate request to the emergency mediation server, which looks up the multiparty locate contacts (e.g., children) as configured in an Emergency Notification Group. The emergency system 130 determines the mobile network for each multiparty contact, and sends commands to the eSMLC server to track the location of each multiparty contact. The system reports the location of each multiparty contact to the dispatcher, and continues to track and provide location information.

In another embodiment, a 911 call is made by a subscriber. A dispatcher determines 911 caller is in a situation of heightened danger. The dispatcher sends a remote monitor request to the emergency mediation server, which transmits a message to the UE to silently turn on device audio and video for the subscriber. The UE continuously transmits audio and video without any notification on the UE that this is occurring, even if turned off or in airplane mode (e.g., the UE will continue to appear off or in airplane mode). The UE remains in this state until the emergency system transmits a message to the UE to stop remote monitoring.

In an embodiment in which a subscriber attempts to dial 911 without RF coverage, the call does not go through (e.g., hiking in a remote area). In such an embodiment, 911 emergency messages are queued up by the UE, and once RF coverage returns, the UE automatically sends text messages to emergency contacts.

In an embodiment, a cellular device is attached to a medical application or linked to device with the capability of providing measurements for medical purposes. In such an embodiment, when a medical emergency occurs (e.g., pulse stops, blood sugar drops), emergency messages with the user's location are automatically sent to members of an emergency contact list as configured in a relevant Emergency Notification Group.

In an embodiment, a subscriber can alert emergency contacts of the presence of an emergency without dialing 911 by providing an input into a UE. The user can define emergency buttons (e.g., roadside assistance, having a baby, sick at school, family member rushed to hospital, car accident) and can specify additional info. The emergency mediation server looks up the subscriber's emergency contacts (family, friends, co-workers, doctors, etc.). The emergency mediation server sends a special alert to devices of contacts indicating an emergency and a location of the subscriber, and sends periodic messages to contacts with updates on the emergency subscriber's location (if applicable to the emergency). The user affected by the emergency can send broadcast updates to group members (e.g., tow truck arrived), including a message indicating that the emergency situation is resolved.

Embodiments of this disclosure apply to a broad variety of emergency service scenarios. Community public emergency services can be supported at a local, regional or national level, including large scale emergencies beyond the resources available by paid emergency personnel such as wide area search and rescue operations and mass casualty events.

Embodiments may be applicable to private localized security such as corporate, college campus and private community security requiring rapid response via local emergency responders. Embodiments also apply to public or private localized security such as event security at a stadium event, theme park or ski resort benefitting from rapid response by nearby responders, and provide support to local or regional businesses providing emergency services such as roadside assistance such that appropriate responders may be notified for nearby requests.

What is claimed is:

1. A method for communications in a cellular network, the method comprising:
receiving location and time data for a plurality of user equipment (UEs) in a cellular communications network at an emergency server that provides emergency services to the plurality of UEs;
storing the location and time data in a secure memory of the emergency server;
receiving an emergency notification associated with a missing person at the emergency server;
correlating, by the emergency server, the stored location and time data with data of the emergency notification to determine a set of volunteer witness UEs; and
transmitting volunteer witness request messages to the set of volunteer witness UEs.

2. The method of claim 1, further comprising:
deleting the location and time data from the secure memory after a predetermined time interval.

3. The method of claim 1, wherein the emergency server receives the location and time data from at least one of an enhanced Serving Mobile Location Server (eSMLC) and a Serving Mobile Location Server (SMLC).

4. The method of claim 1, wherein the emergency notification is received from a law enforcement agency.

5. The method of claim 1, wherein the emergency notification includes location and time data of an event associated with disappearance of the missing person.

6. The method of claim 1, wherein the correlating comprises:
establishing a first geofence around a location associated with the missing person; and
determining a first portion UEs of the plurality of UEs that are within an area bounded by the geofence within a time associated with the missing person,
wherein the first portion of UEs is the set of volunteer witness UEs.

7. The method of claim 6, wherein the emergency server stores authorizations to contact the plurality of UEs regarding volunteer witness services.

8. The method of claim 7, further comprising:
receiving at least one response to the volunteer witness request messages; and
transmitting the received response to a law enforcement agency.

9. An emergency management system coupled to a cellular telecommunications network, the system comprising:
an emergency server with a memory, a processor, and at least one non-transitory computer readable medium with executable instructions stored thereon which, when executed by the processor, perform the following operations:
receiving location and time data for a plurality of user equipment (UEs) in a cellular communications network at the emergency server that provides emergency services to the plurality of UEs;
storing the location and time data in a secure memory of the emergency server;
receiving an emergency notification associated with a missing person at the emergency server;
correlating, by the emergency server, the stored location and time data with data of the emergency notification to determine a set of volunteer witness UEs; and
transmitting volunteer witness request messages to the set of volunteer witness UEs.

10. The system of claim 9, wherein the operations further comprise:
deleting the location and time data from the secure memory after a predetermined time interval.

11. The system of claim 9, wherein the emergency server receives the location and time data from at least one of an enhanced Serving Mobile Location Server (eSMLC) and a Serving Mobile Location Server (SMLC).

12. The system of claim 9, wherein the emergency notification is received from a law enforcement agency.

13. The system of claim 9, wherein the emergency notification includes location and time data of an event associated with disappearance of the missing person.

14. The system of claim 9, wherein the correlating comprises:
establishing a first geofence around a location associated with the missing person; and
determining a first portion UEs of the plurality of UEs that are within an area bounded by the geofence within a time associated with the missing person,
wherein the first portion of UEs is the set of volunteer witness UEs.

15. The system of claim 9, wherein the emergency server stores authorizations to contact the plurality of UEs regarding volunteer witness services.

16. The system of claim 9, wherein the operations further comprise:
receiving at least one response to the volunteer witness request messages; and
transmitting the received response to a law enforcement agency.
